(19) United States
(12) Patent Application Publication
(10) Pub. No.: US 2026/0039982 A1
(43) Pub. Date: Feb. 5, 2026

(54) SMART AND DYNAMIC OPTICAL NETWORK SPECTRAL EFFICIENT CHANNEL

(71) Applicants: AT&T Communications Services India Private Limited, Bangalore (IN); AT&T Intellectual Property I, L.P., Atlanta, GA (US)

(72) Inventors: Mritunjay Pandey, Bangalore (IN); Lynn Rivera, Naples, FL (US); Subhash Kapoor, Wall, NJ (US)

(73) Assignees: AT&T Communications Services India Private Limited, Bangalore (IN); AT&T Intellectual Property I, L.P., Atlanta, GA (US)

(21) Appl. No.: 18/792,772

(22) Filed: Aug. 2, 2024

(51) Int. Cl. H04Q 11/00; H04L 41/12; H04L 41/16

(52) U.S. Cl. CPC H04Q 11/0062; H04L 41/12; H04L 41/16; H04Q 2011/009

(57) ABSTRACT

Aspects of the subject disclosure may include, for example, determining a topology of a network, wherein the network includes a plurality of network elements (NEs) and at least one optical network-based fronthaul, at least one optical network-based midhaul, or combination thereof, for one or more routes associated with one or more of the plurality of NEs identified based on the topology, applying one or more sets of parameters for that route, obtaining data relating to the network based on the applying the one or more sets of parameters, training one or more AI models using the data, resulting in one or more trained AI models, and utilizing the one or more trained AI models to generate one or more predictions regarding spectral efficiency relating to the at least one optical network based fronthaul, the at least one optical network-based midhaul, or the combination thereof. Other embodiments are disclosed.

### FIELD OF THE DISCLOSURE

The subject disclosure relates to identifying and facilitating efficient spectrum allocations—e.g., for a 5G (or higher generation technology) optical network-based fronthaul and/or midhaul.

### BACKGROUND

The Open Radio Access Network (O-RAN) architecture has become a crucial component in 5G networks, enabling service providers to build their networks using commercial off the shelf (COTs) components from different vendors. In this architecture, a RAN intelligent controller (RIC) facilitates control of communications between a core network and central units (CUs), distributed units (DUs), and radio units (RUs). To facilitate seamless communications between these components, network providers have adopted optical fiber networks, particularly as fronthaul connections between DUs and RUs. This is typically achieved through either wavelength division multiplexing (WDM) or passive optical network (PON) technologies. However, there are limitations to consider when using a PON or a WDM network for an optical fronthaul. For instance, if all available channels have been exhausted on a particular path, it may not be possible to accommodate on-demand traffic on that path without compromising signal quality. Additionally, during peak usage periods, such as concerts, sporting events, or festivals, the limited spectrum space for on-demand traffic can lead to congestion and poor signal strength. Factors that influence signal strength in a 5G optical fronthaul PON or WDM network include the distance between DUs and CUs, the gain profile, absorption losses, scatterings (such as Rayleigh and Mie scattering), the dispersion profile (e.g., chromatic dispersion, polarization-mode dispersion (PMD), and/or modal dispersion), and optical fiber characteristics. Furthermore, the changing optical characteristics of a 5G optical fronthaul PON or WDM network can impact existing channels or cause significant issues when launching new channels. This includes changes due to non-linearity, such as refractive index changes caused by the addition of more high-capacity channels, PMD caused by fiber twists, and changes in amplified spontaneous emission (ASE) noise due to the need for increased amplification. Changes in laser characteristics over time can also impact signal quality.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A illustrates an example network in which a PON is employed for a fronthaul between DU(s) and RU(s), in accordance with various aspects described herein.

FIG. 2B illustrates an example network in which a WDM network is employed for a fronthaul between DU(s) and RU(s), in accordance with various aspects described herein.

FIG. 2C illustrates an example modular architecture of a software-defined access optical controller (SDAOC), in accordance with various aspects described herein.

FIG. 2D illustrates an example artificial intelligence (AI)/machine learning (ML) system that may be incorporated in or utilized by the SDAOC of FIG. 2C, in accordance with various aspects described herein.

FIG. 2E illustrates another example AI/ML system that may be incorporated in or utilized by the SDAOC of FIG. 2C, in accordance with various aspects described herein.

FIG. 2F is a diagram illustrating an example process that the SDAOC of FIG. 2C may be configured to perform, in accordance with various aspects described herein.

FIG. 2G depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes illustrative embodiments of an SDAOC that is capable of predicting network spectral efficiency and recommending (e.g., optimal) spectrum allocations—e.g., for a 5G (or higher generation technology) fronthaul network that is provided via a PON or a WDM network. A higher spectral efficiency, which may, for instance, be measured in bits per second per Hertz (bps/Hz), means that more data can be transmitted within a fixed bandwidth. In exemplary embodiments, the SDAOC may be configured to learn the physical characteristics of an optical network, including parameters such as the distance between DUs and RUs, the gain profile, absorption losses, scattering, dispersion, optical fiber characteristics, and/or the like, and analyze this data to resolve issues relating to congestion and/or poor signal strength. In one or more embodiments, the SDAOC may be configured provide a controller service that creates a database of physical characteristics and analyzes the data using an analytics engine to predict future demands on the network. For instance, the SDAOC may launch channels with multiple combinations of optical properties, create a database of applied properties, and (e.g., continuously) analyze the network performance. In certain embodiments, the SDAOC may be equipped with one or more ML (e.g., deep learning (DL)) models that are capable of predicting spectral efficiency and/or recommending alternative spectrum allocations (e.g., that maintain similar costs, hops, and/or network latency). The SDAOC may be configured to monitor optical time-domain reflectometer (OTDR) notifications and feed them into the one or more ML models to facilitate the spectral efficiency predictions and/or spectrum allocation recommendations.

Exemplary embodiments of the SDAOC provide for novel fronthaul optical network management by learning the characteristics of the PON or WDM network via (e.g., real-time or near real-time) data collection and analytics. This advantageously enables intelligence-driven decisions with regard to new channel additions and fiber cuts. The SDAOC's predictive capabilities enable smart and dynamic channel spectral efficiency predictions for fiber-based networks between DUs and RUs, which allows for flexible modulation formats, adaptive forward error correction (FEC), coherent multiple-input multiple-output (MIMO) receivers, and flexible data rates and types. These predictive capabilities also enable channel/bandwidth tuning and reachability improvement or optimization. By utilizing DL algorithms, for instance, the SDAOC may determine spectrum allocations with minimal to no impact to existing traffic. The algorithm(s) may utilize knowledge from the SDAOC to compute the impact of channel movements (e.g., each channel movement) and provide options for taking action during planned maintenance windows. In a case where an operator chooses to have an action taken during a maintenance window, the SDAOC may automatically perform the action during that time, which can reduce or minimize service disruptions and ensure reliable data transmission. It will be understood and appreciated that embodiments of the SDAOC increase or maximize utilization of the highly-valued and limited PON or WDM network spectrum by way of its ML algorithm(s). The SDAOC also resolves the problem of holes in the spectrum that might result from newly-launched channels. The database(s) built by the SDAOC may also be mined for intelligence, which enables adaptation of any (e.g., 5G or higher generation technology) optical fronthaul network.

While embodiments of the SDAOC are described herein in the context of a fronthaul network (i.e., between DUs and RUs), it will be understood and appreciated that the SDAOC may be additionally, or alternatively, be configured to provide optical network management for a midhaul network (i.e., between CUs and DUs).

One or more aspects of the subject disclosure include a device, comprising a processing system including a processor, and a memory that stores executable instructions that, when executed by the processing system, facilitate performance of operations. The operations can include determining a topology of a network, wherein the network includes a plurality of network elements (NEs) and at least one optical network-based fronthaul, at least one optical network-based midhaul, or a combination thereof. Further, the operations can include, for one or more routes associated with one or more of the plurality of NEs identified based on the topology, applying one or more sets of parameters for that route. Further, the operations can include obtaining data relating to the network based on the applying the one or more sets of parameters. Further, the operations can include training one or more artificial intelligence (AI) models using the data, resulting in one or more trained AI models. Further, the operations can include utilizing the one or more trained AI models to generate one or more predictions regarding spectral efficiency relating to the at least one optical network-based fronthaul, the at least one optical network-based midhaul, or the combination thereof.

One or more aspects of the subject disclosure include a non-transitory machine-readable medium, comprising executable instructions that, when executed by a processing system including a processor, facilitate performance of operations. The operations can include determining a topology of a network, wherein the network includes a plurality of nodes and at least one optical network-based fronthaul. Further, the operations can include, for one or more network paths associated with one or more of the plurality of nodes identified based on the topology, applying one or more sets of parameters to one or more components associated with that network path. Further, the operations can include collecting data relating to the network based on the applying the one or more sets of parameters. Further, the operations can include training one or more deep learning (DL) models using the data, resulting in one or more trained DL models. Further, the operations can include utilizing the one or more trained DL models to generate one or more predictions regarding spectral efficiency relating to the at least one optical network-based fronthaul.

One or more aspects of the subject disclosure include a method. The method can comprise obtaining, by a processing system including a processor, information regarding a topology of a network, wherein the network includes a plurality of nodes and at least one optical network-based fronthaul, at least one optical network-based midhaul, or a combination thereof. Further, the method can include, for one or more routes associated with one or more of the plurality of nodes identified based on the topology, applying, by the processing system, one or more sets of parameters to one or more components associated with that route. Further, the method can include performing, by the processing system, testing of the network to obtain data relating to the network based on the applying the one or more sets of parameters. Further, the method can include training, by the processing system, one or more machine learning (ML) models using at least a portion of the data, resulting in one or more trained ML models. Further, the method can include leveraging, by the processing system, the one or more trained ML models to generate one or more predictions regarding spectral efficiency relating to the at least one optical network-based fronthaul, the at least one optical network-based midhaul, or the combination thereof. Further, the method can include causing, by the processing system, one or more adjustments to be made to at least a portion of the network based on the one or more predictions.

Other embodiments are described in the subject disclosure.

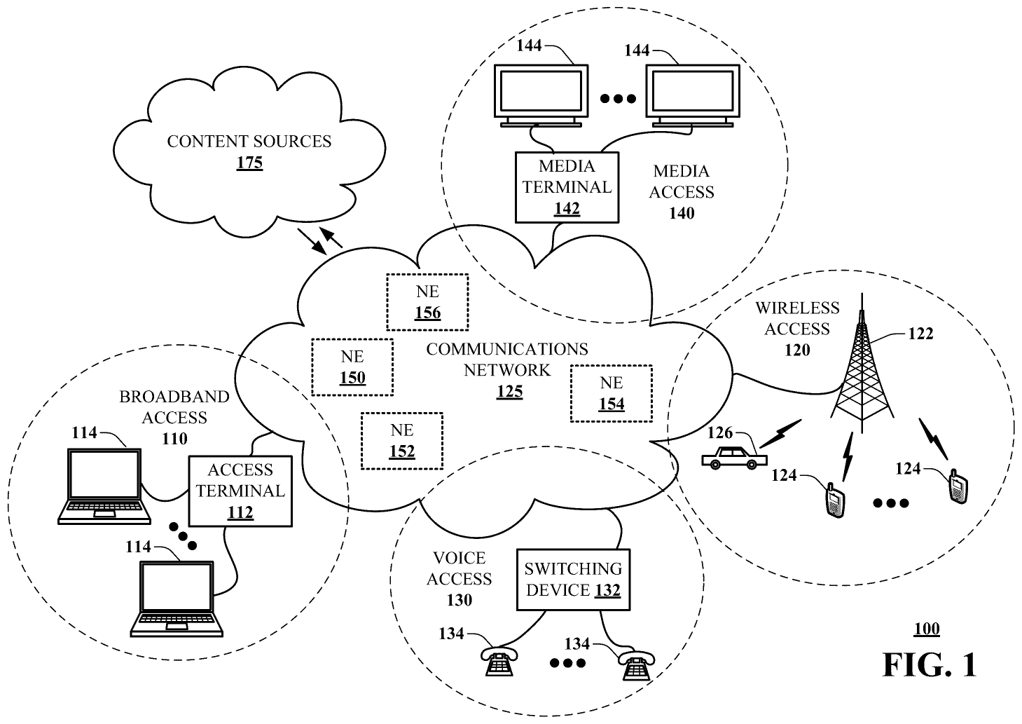

Referring now to FIG. 1, a block diagram is shown illustrating an example, non-limiting embodiment of a system 100 in accordance with various aspects described herein. For example, system 100 can facilitate, in whole or in part, efficient spectrum allocations—e.g., for a 5G (or higher generation technology) optical network-based fronthaul and/or midhaul. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VolP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

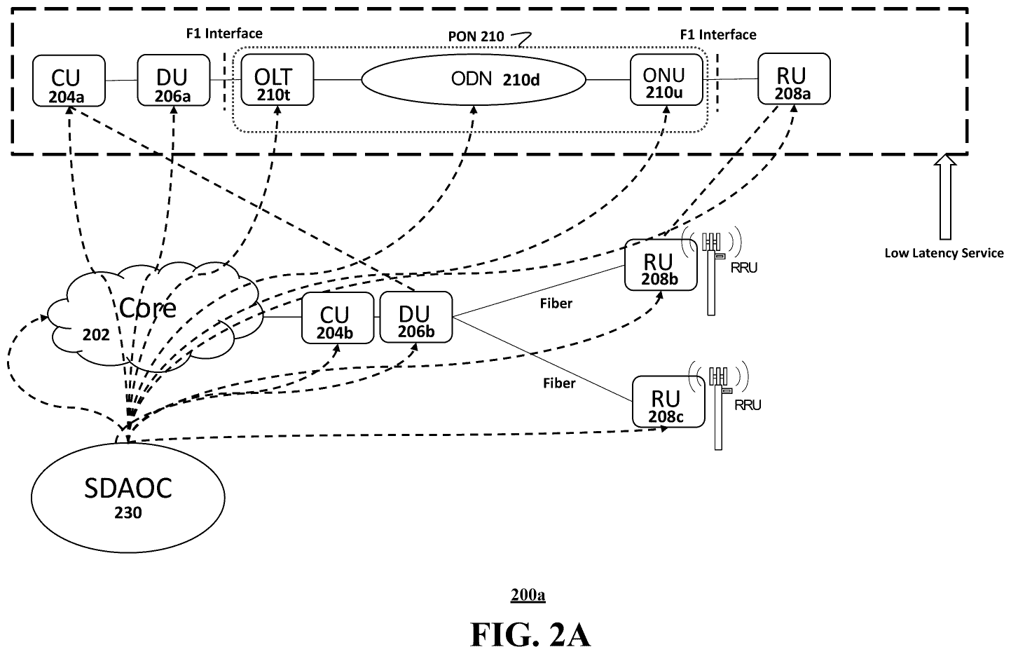

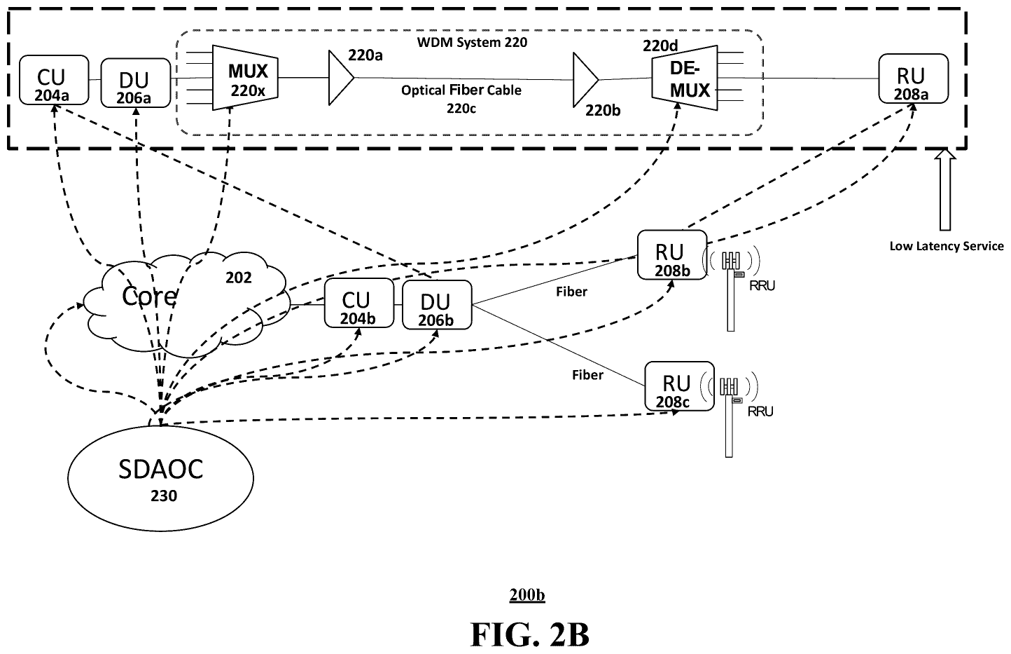

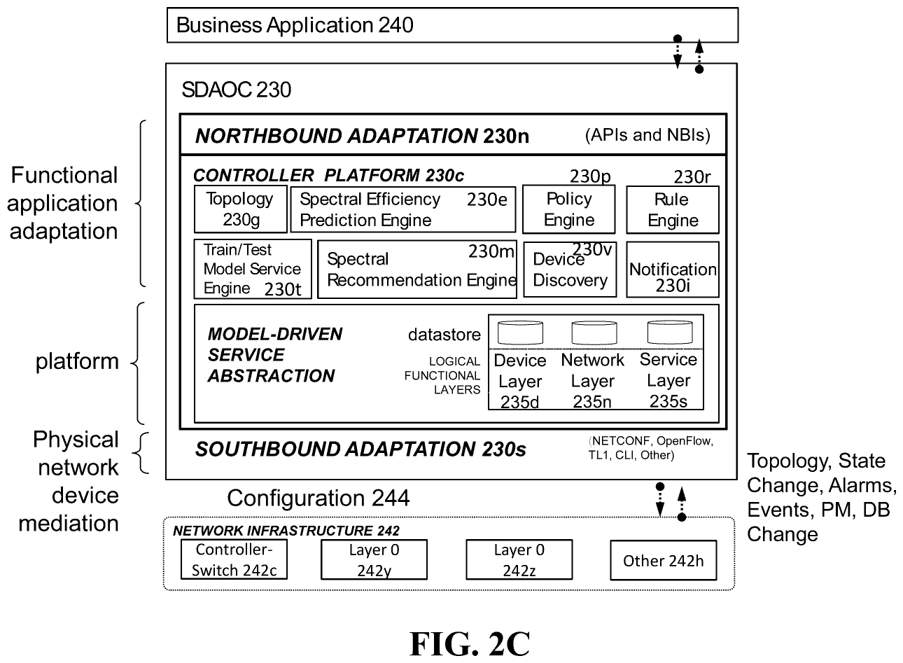

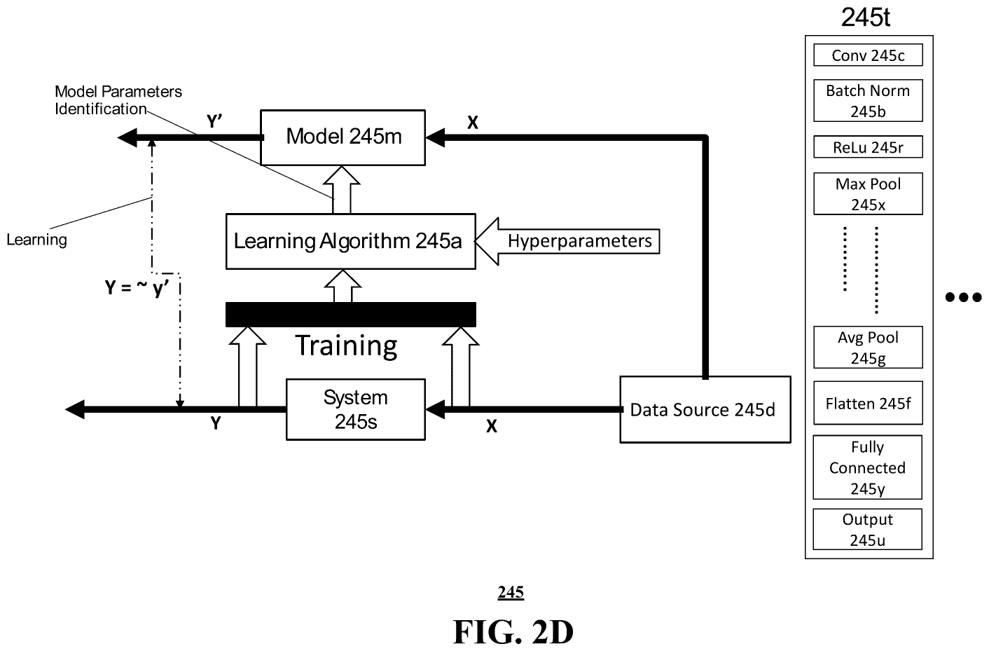

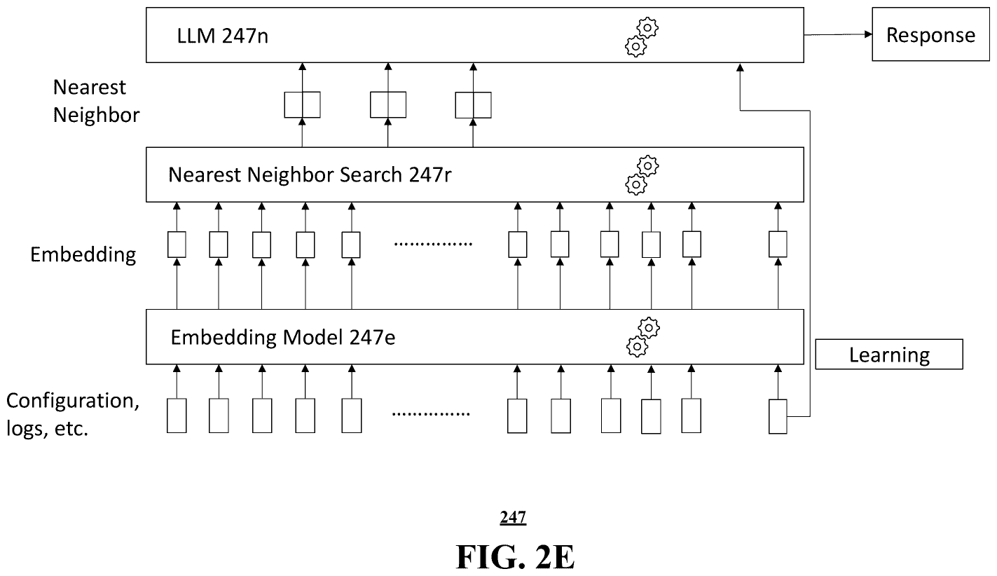

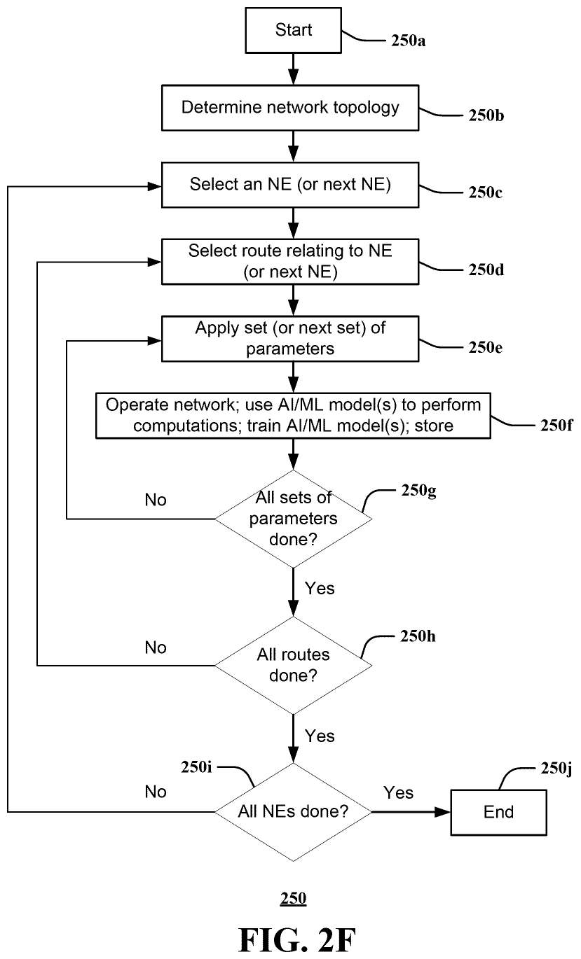

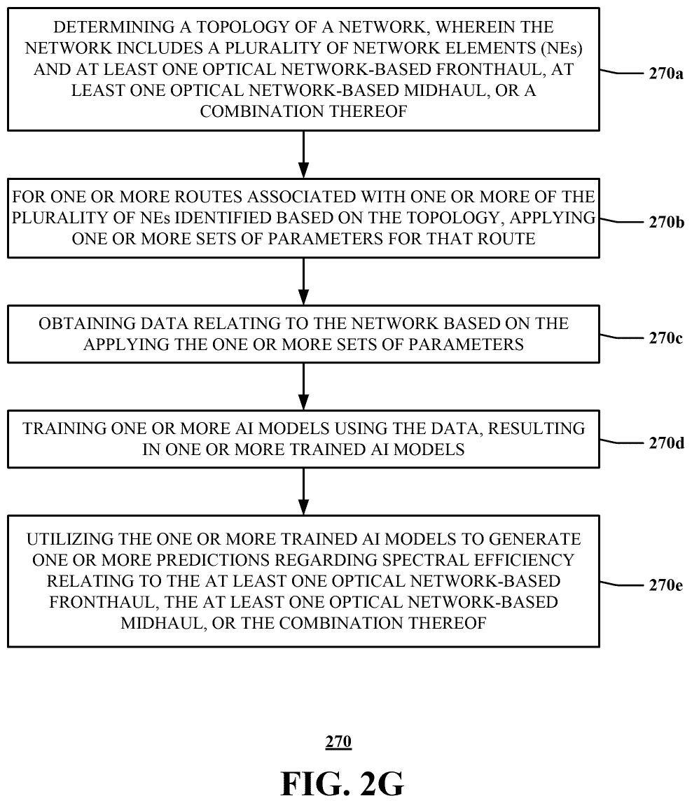

FIG. 2A illustrates an example network 200a in which a PON is employed for a fronthaul between DU(s) and RU(s), in accordance with various aspects described herein. The example network 200a may be an O-RAN-based network in which a core network 202 is communicatively coupled to one or more RANs. An SDAOC 230 may be communicatively coupled to the core network 202, and may provide for novel fronthaul optical network management as described in more detail below. The core network 202 can include a 5G network, an evolved packet core (EPC) network, a higher generation network, or any combination thereof. The RAN may be or may include a virtual RAN (vRAN) (e.g., in an O-RAN implementation) in which software is decoupled from hardware and implementation thereof is in accordance with principles of network function virtualization (NFV), where the control plane is separated from the data plane. The vRAN may include a centralized set of baseband units located remotely from antennas and remote radio units and may be configured to share signaling amongst cells. Although not shown, in various embodiments, a RAN may include a network service management platform and a RIC. The RIC may include a first RIC portion implemented, or otherwise incorporated, in the network service management platform. The first RIC portion may include a CU (e.g., a base station CU, such as a gNodeB (gNB) CU or the like) that provides a CU applications layer as well as a CU control plane CU-CP and a CU user plane CU-UP. CUs 204a and 204b are illustrated in FIG. 2A. In various embodiments, the first RIC portion may be configured to operate in non-real-time, and a second RIC portion may be configured to operate in near real-time. The particular functions performed by the RIC portions can vary based on various criteria, including implementing changing parameters or requirements for the network, and can also include redundancy and/or dynamic switching of functions (including functions described herein) between the RIC portions. Each CU may be communicatively coupled to one or more DUs, each of which may, in turn, be communicatively coupled to one or more RUs. As illustrated in FIG. 2A, the CU 204a may be coupled to a DU 206a, and the CU 204b may be coupled to a DU 206b. DUs 206a, 206b may include baseband units (e.g., base station DUs, such as gNB DUs or the like) configured to perform signal processing, user equipment (UE) scheduling, and/or the like. In exemplary embodiments, each of one or more DUs 206a, 206b may be implemented as a virtual DU (vDU). In various embodiments, a RAN may also include RUs. RUs 208a, 208b, 208c are illustrated in FIG. 2A.

The DU 206a may be coupled to the RU 208a via a fiber-based fronthaul network, particularly a PON 210. The PON 210 may include an optical line terminal (OLT) 210t, an optical distribution network (ODN) 210d, and an optical network unit (ONU) 210u. The OLT 210t may be configured to send/receive Ethernet data to/from the ONUs 210u, and may initiate and control a ranging process by recording ranging information for data transmissions. The OLT 210t may also allocate bandwidth for the ONU 210u as well as control the start time and size of a sending window to prevent congestion or conflicts in the network. The ODN 210d may include optical fibers and passive optical splitters or couplers for coupling the OLT 210t and the ONU 210u. The DU 206b may be coupled to RUs 208b, 208c via respective fiber-based fronthaul networks (e.g., the same as or similar to the PON 210). The RUs 208a, 208b, 208c may communicatively couple (e.g., via an air interface) with UEs (not illustrated). In various embodiments, the RUs 208a, 208b, 208c may include remote radio units, antennas, and/or the like. In certain embodiments, one or more of the RUs 208a, 208b, 208c may include one or more antenna arrays (e.g., massive MIMO arrays).

While two CUs (204a and 204b), two DUs (206a and 206b), and three RUs (208a, 208b, and 208c) are illustrated in FIG. 2A, it will be understood and appreciated that the example network 200a may include more or fewer CUs, DUs, and/or RUs. The CUs, DU, and RUs illustrated may, by way of the fronthauls (between DUs and RUs), midhauls (between CUs and DUs) and backhauls (between the core network 202 and the CUs), provide (e.g., controlled) connectivity between the core network 202 and UEs. In one or more embodiments, fronthauls, midhauls, and/or backhauls may conform to O-RAN standards. In various embodiments, the network system 200a can include various heterogeneous cell configurations with various quantities of cells and/or types of cells.

FIG. 2B illustrates an example network 200b in which a WDM network is employed for a fronthaul between DU(s) and RU(s), in accordance with various aspects described herein. The example network 200b of FIG. 2B is generally the same as the example network 200a of FIG. 2A, with the exception that a WDM 220 is employed in the example network 200b for interconnecting the DU 206a and the RU 208a. The WDM system 220 may be implemented in a transceiver. The transmitter portion of a transceiver may include a multiplexer (MUX) 220x, and the receiver portion of the transceiver may include a de-multiplexer (DE-MUX) 220d. While only a single transmission direction is shown for the WDM system 220 (i.e., from the DU 206a to the RU 208a), the WDM system 220 may include a respective transceiver at each end (i.e., on the DU 206a side and on the RU 208a side) to allow for transmissions in both directions. In any case, an amplifier 220a, an optical fiber cable 220c, another amplifier 220b may interconnect the transceivers. The MUX 220x of a transceiver may combine multiple low-power optical signals into a single high-power signal over a single fiber. The amplified signal may be transmitted through the optical fiber cable 220c, passing through the amplifier 220b to maintain signal strength. At the receiving end, the signal may be demultiplexed by the DE-MUX 220d into its original low-power signals.

It is to be understood and appreciated that an example network may include a mixture of different types of optical networks as fronthauls between DUs and RUs-i.e., a mixture of what is shown in FIG. 2A and FIG. 2B. For instance, an example network may employ PONs to interface some DU/RU pairs and may employ WDM networks to interface other DU/RU pairs.

FIG. 2C illustrates an example modular architecture of an SDAOC 230, in accordance with various aspects described herein. In exemplary embodiments, the modular architecture of the SDAOC 230 may provide multi-layer and/or multi-vendor support. The modular architecture may include a controller platform 230c, North Bound Interface (NBI) adapters 230n (e.g., application programming interfaces (APIs)), and South Bound Interface (SBI) adapters 230s. The NBI adapters 230n may couple the controller platform 230c to upper layers such as user interfaces, Operations & Business Support Systems (OSS/BSS), and/or the like. The SBI adapters 230s may provide multiple interfaces for coupling the controller platform 230c with various devices (e.g., routers, switches, and/or other network elements) using protocols or interfaces, such as Network Configuration Protocol (Netconf), command line interface (CLI), transaction language 1 (TL1), or proprietary interface(s).

The controller platform 230c may include a topology service 230g that is configured with a collection engine that collects data regarding the network and utilizes the data to create a comprehensive topology map. The collection engine of the topology service 230g may collect the data via the SBI adapters 230s. In various embodiments, the collection engine may additionally collect network data based on (e.g., all possible) parameters that are applied for various routes associated with various network elements (NEs) (or nodes), such as CUs, DUs, RUs, PON components, WDM network components, Reconfigurable Optical Add/Drop Multiplexer (ROADM) devices, etc., and may record corresponding measured states. In one or more embodiments, the topology service 230g may deploy or run test transponders on (e.g., individual) NEs, apply (e.g., all possible) parameters, and obtain observations or results of the applied configurations from the test transponders.

The controller platform 230c may include a device discovery service 230v that is configured to discover devices on the network, including those at Layer 0 (L0) (e.g., the photonics layer), L1, L2, and/or L3. The collection engine of the topology service 230g may collect data for devices that have been discovered by the device discovery service 230v.

The controller platform 230c may include a spectral efficiency prediction engine 230e that is configured to leverage AI model(s) to predict the (e.g., optimally efficient) optical spectrum frequency that can be used in a fronthaul networks (e.g., PONs or WDM networks) between DUs and RUs. In various embodiments, the spectral efficiency prediction engine 230e may predict the spectral efficiency for (e.g., cach of) one or more (e.g., a combination) of frequencies in a fronthaul network. In certain embodiments, the spectral efficiency prediction engine 230e may additionally be configured to similarly predict the (e.g., optimally efficient) optical spectrum frequency in midhaul networks between CUs and DUs.

The controller platform 230c may include a spectral efficiency recommendation engine 230m that generates recommendations for spectrum allocation/usage based on predictions provided by the spectral efficiency prediction engine 230e. The spectral efficiency recommendation engine 230m may, for instance, recommend one or more frequencies (e.g., the optimal frequency) of one or more channels that should be used in PONs and/or WDM networks so as to ensure increased (e.g., optimized) efficiency and reduced (e.g., minimal) interference.

The controller platform 230c may include a policy engine 230p that is configured to enforce spectrum configuration policies on NE(s) based on recommendations from the spectral efficiency recommendation engine 230m.

The controller platform 230c may include a rule engine 230r that is configured to activate policy enforcement on NE(s). The rule engine 230r may maintain or log the states of actions taken, and may calculate rewards or rank actions taken. This can ensure that the network is configured according to predefined rules and/or (e.g., minimum, maximum) thresholds, such as those that may be defined by network subject matter experts.

The controller platform 230c may include a train/test model service engine 230t that is configured to process data that is collected by the topology service 230g. This train/test model service engine 230t may configure and train AI model(s) using the collected data, and may generate datasets (e.g., sets of parameters) for training and testing purposes. The train/test model service engine 230t may also embed (e.g., fully-connected) layer vector geometric data into a vector database to facilitate efficient querying and analysis. Once training of a given model is complete, the train/test model service engine 230t may evaluate the model's accuracy by querying the trained AI model against the vector database so as to verify the effectiveness of the trained model.

The controller platform 230c may include a notification engine 230i that is configured to monitor network health to identify configuration issues, node downtime, fiber cuts, and/or the like. The notification engine 230i may output notifications regarding identified problems. In some embodiments, the notification engine 230i may output such notifications to the spectral efficiency prediction engine 230e and/or the spectral efficiency recommendation engine 230m to facilitate predictions/recommendations of the (e.g., optimal) frequency to use in a fronthaul and/or a midhaul.

The controller platform 230c may include a datastore or respective datastores for a device layer 235d, a network layer 235n, and a service layer 235s. The datastore(s) may store vector data, topology data, device discovery data, network data, service data, and/or other relevant information. The datastore(s) may enable the controller platform 230c to perform various of its functions, such as, for instance, policy enforcement, spectrum prediction, and so on.

In various embodiments, the SDAOC 230 may be configured to support various data rates, such as, for instance, data rates from 20 megabits/second (Mb/s) to 40 gigabits/second (GB/s) and beyond. In one or more embodiments, the SDAOC 230 may be configured to support various modulation formats (e.g., quadrature amplitude modulation (QAM) with any suitable number of states, such as 64 or 32; phase shift keying (PSK) in combination with QAM with any suitable number of states; pulse position modulation (PPM) with QAM or quadrature phase shift keying (QPSK); and so on). In certain embodiments, the SDAOC 230 may be configured to support FEC, such as standard FEC, enhanced FEC, unified FEC, adaptive FEC, etc. In one or more embodiments, the SDAOC 230 may be configured to support various data types/technologies, such as Ethernet, optical transport networks (OTNs), fiber channels, etc.

In exemplary embodiments, the SDAOC 230 may be configured to improve or optimize the performance of a (e.g., 5G) fronthaul between a DU and an RU (and/or a midhaul between a CU and a DU) by performing various operations, including data collection, computation, and generation, feeding of data into AI/ML model(s) to learn network characteristics, making data-driven predictions of spectral efficiency in the fronthaul/midhaul, and/or providing recommendations for improvement/optimization.

FIG. 2D illustrates an example AI/ML system 245 that may be incorporated in or utilized by the SDAOC 230, in accordance with various aspects described herein. In various embodiments, the AI/ML system 245 may correspond to one or more of the models described above with respect to the SDAOC 230, such as, for instance, one or more of the spectral efficiency prediction engine 230e, the spectral efficiency recommendation engine 230m, the train/test model service engine 230t, etc. A convolutional neural network (CNN) architecture 245t (of which there may be more than one) may include various layers, including a convolutional layer 245c, a batch normalization layer 245b, a rectified linear unit 245r, a max pooling layer 245x, an average pooling layer 245g, a flattening layer 245f, and a fully connected layer 245y. The CNN 245t may be used to process input data and produce outputs (245u). The ML architecture may involve a data source 245d that is fed into two paths. The first path may lead to a model 245m, which intakes input X. The data source 245d may represent a dataset that contains features or attributes for training and evaluating the performance of the model 245m. The second path may lead to a system 245s, also with input X. The system 245s may be an iterative process that refines its predictions based on feedback. The output Y of this system 245s may represent a predicted outcome or label associated with the input data. The learning algorithm 245a may update the parameters of the model 245m based on the feedback from the system 245s and hyperparameters. The learning algorithm 245a may be configured to improve or optimize the performance of the model 245m by adjusting its parameters so as to reduce or minimize any discrepancies between predicted outputs Y′ and actual labels Y. Model parameters identification (or learned parameters) may be used to update the model 245m's weights or biases. This process may be repeated multiple times until convergence or a stopping criterion is reached. The dotted two-way arrow between output Y′ and output Y represents the iterative refinement of predictions through the AI/ML system.

FIG. 2E illustrates an example AI/ML system 247 that may be incorporated in or utilized by the SDAOC 230, in accordance with various aspects described herein. In various embodiments, the AI/ML system 247 may correspond to one or more of the models described above with respect to the SDAOC 230, such as, for instance, one or more of the spectral efficiency prediction engine 230e, the spectral efficiency recommendation engine 230m, the train/test model service engine 230t, etc. In some embodiments, the AI/ML systems 245 and 247 may be utilized together or as substitutes for one another. As illustrated in FIG. 2E, an embedding model 247e receives various inputs, such as configuration information, logs, etc., and may produce embedding outputs that may be fed into a nearest neighbor search block 247r. The nearest neighbor search block 247r may use the embeddings generated by the embedding model 247e to find the most similar or closest neighbors based on a distance metric. The output of the nearest neighbor search block 247r—i.e., nearest neighbor—may be passed to an LLM 247n. In one or more embodiments, the LLM 247n may be a transformer-based architecture designed for natural language processing tasks. The LLM 247n may process the nearest neighbor and produce a response, which may include a predicted label, a recommended action, or some other form of generated text. The embedding model 247e may not only be used for nearest neighbor search, but may also provide a source of information or context that can be leveraged by the LLM 247n to improve its performance.

FIG. 2F is a flow diagram illustrating an example process that the SDAOC 230 may be configured to perform, in accordance with various aspects described herein. The process may begin at step 250a. At step 250b, the SDAOC 230 may determine the network topology. For example, the topology service 230g of the SDAOC 230 may determine the topology of the network (or an overall “network view”) based on stored information, transmitted test signals, received requests/notifications, and/or the like.

At step 250c, the SDAOC 230 may select an NE. For example, the SDAOC 230 may randomly select an NE, such as a CU, a, DU, or an RU. As another example, the SDAOC 230 may select an NE that is associated with a fronthaul optical network or a midhaul optical network.

At step 250d, the SDAOC 230 may select a route relating to the NE. In some embodiments, the NE may be a destination NE, and the SDAOC 230 may additionally select a source NE. In these embodiments, the SDAOC 230 may identify a route between the source and destination NEs. As an example, in a case where the SDAOC 230 has selected the RU 208a as a destination NE, the SDAOC 230 may select another NE, such as a device in the core network 202, the DU 206a, or the CU 204a. In this example, the SDAOC 230 may select a route between the device in the core network 202 and the RU 208a, a route between the CU 204a and the RU 208a, or a route between the DU 206a and the RU 208a.

At step 250e, the SDAOC 230 may apply a set of parameters to the network, and at step 250f, the SDAOC 230 may operate the network—e.g., by causing or allowing transmissions to be communicated over the route—based on those parameters. The parameters may include any suitable network-related parameters, such as, for instance, optical laser type, laser frequency, laser intensity, number of channels, channel bandwidth, data modulation format, FEC type, and so on. The SDAOC 230 may utilize one or more AI/ML models to perform computations during the operation of the network. In various embodiments, the computations may include some or all of the following:
Spectral efficiency (SE)=Log₂ (M)÷(N/2), where M is the number of symbols and N is dimensionality
Asymptotic Power Efficiency (APE)=gamma=d²ₘᵢₙ/4E_{b}=d²ₘᵢₙ log₂ (M)/4Eₛ
Average symbol rate

$${E}_{s} = \frac{1}{M} {\sum }_{k = 1}^{M} {‖ {c}_{k} ‖}^{2}$$

Average energy per bit AE_{b}=Es/Log₂ (M)
Signal attenuation per unit length in decibels

$$( dB ) = {α}_{db} * L = 10 {log}_{10} \frac{P i}{P o} ,$$

where L is optical length, Pi is launch power, and Po is received power.
Stimulated Brillouin Scattering (SBS) P_{B}=4.4×10⁻³ d²λ² α_{dB}v watts
Stimulated Raman Scattering (SRS):
   P_{R}=5.9×10⁻²d² λα_{dB} watts, where d and λ are fiber core diameter and operating wavelength measured in micrometers, respectively, where α_{dB} is fiber attenuation in dB per kilometer, and where v is bandwidth of injection laser
Rayleigh Scattering:

$${Γ}_{R} = \frac{8 π3}{3 λ 4} {n}^{8} p 2 {β}_{c} K {T}_{F} ,$$

where Γ_{R} is the Rayleigh scattering coefficient, Λ is the optical wavelength, n is the refractive index of the medium, p is average photo elastic coefficient, β_{c} is the isothermal compressibility at a fictive temperature T_{F}, and K is Boltzmann's constant
For a constant refractive index, the remaining parameters may be constant (e.g., depending on the wavelength of light used)
The reflection coefficient (RC) can be computed for each wavelength
Material dispersion:

$$M = \frac{λ}{c} \vert \frac{d 2 n 1}{cd λ 2} \vert ,$$

where root mean square (RMS) pulse broadening is given by:

$${σ}_{m} \approx \frac{σ λ L}{c} \vert λ \frac{d 2 n 1}{cd λ2} \vert = {σ}_{λ} LM$$

Dispersion in single mode fiber:
   Group delay for a light pulse propagating along a unit length of single mode fiber may be given by:

$${τ}_{g} = \frac{1}{c} \frac{d β}{dk}$$

Computation of SBS and SRS thresholds can be useful for keeping launch powers of channels in control so as to reduce or avoid scatterings in the fiber.

At step 250g, the SDAOC 230 may determine if all sets of parameters have been applied for testing and data collection/computation purposes. If the SDAOC 230 determines that not all sets of parameters have been applied (NO), the process may return to step 250e to apply another set or a next set of parameters. If the SDAOC 230 determines that all sets of parameters have been applied (YES), the process may proceed to step 250h.

At 250h, the SDAOC 230 may determine if all routes for the NE have been selected for testing and data collection/computation purposes. For example, where the NE is a destination NE, the SDAOC 230 may determine whether there are any other routes available between that NE and a source NE. If the SDAOC 230 determines that not all routes for the NE have been selected (NO), the process may return to step 250d to select another route or a next route. If the SDAOC 230 determines that all routes for the NE have been selected (YES), the process may proceed to step 250i.

At 250i, the SDAOC 230 may determine if all NEs in the network topology have been selected for testing and data collection/computation purposes. If the SDAOC 230 determines that not all NEs have been selected (NO), the process may return to step 250c to select another NE or a next NE. If the SDAOC 230 determines that all NEs have been selected (YES), the process may end at step 250j. In this way, the SDAOC 230 may apply parameters and perform testing, data collection, etc. for all nodes in the network topology.

In various embodiments, the SDAOC 230 may repeat some or all of the above-described steps for a specific interval of time (which can, for instance, be administrator configurable), after which the process may end.

In one or more embodiments, the SDAOC 230's use of AI/ML model(s), such as that relating to step 250e or one or more other steps in the process, may include the use of the training/testing model engine 230t, the spectral efficiency prediction engine 230c, the spectral efficiency recommendation engine 230m, the policy engine 230p, and/or the rule engine 230r. Some or all of the results from actions performed by these model(s) may be stored (e.g., in a datastore) and/or accessed for use. By analyzing collected test data, the SDAOC 230 may identify patterns and correlations that inform its predictions. In one or more embodiments, the SDAOC 230's predictive capabilities may be guided by both AI/ML model results and rule-based policy engine insights. For instance, the SDAOC 230 may leverage the training/testing model engine 230t to generate test data relating to sets or combinations of parameters to be applied for one or more routes associated with one or more NEs under test, may use collected data to train the spectral efficiency prediction engine 230e and/or the spectral efficiency recommendation engine 230m, and may use the spectral efficiency prediction engine 230e and/or the spectral efficiency recommendation engine 230m, in conjunction with the policy engine 230p and/or the rule engine 230r, to derive predictions/recommendations for spectral efficiency that are in accordance with policies/rules.

The SDAOC 230 may, through these model(s), learn to make intelligent decisions with respect to identifying and/or launching of channel(s) between a DU and an RU (and/or between a CU and a DU) that are spectrally efficient. For instance, the SDAOC 230 may find the communication channel (e.g., band of frequencies) that offers the best or highest spectral efficiency among multiple possible channels. In various embodiments, the SDAOC 230 may be capable of performing analytics as network characteristics are (e.g., continuously) learned through network testing, and forecasting future trends in (e.g., 5G) fronthaul/midhaul optical network spectral efficiency.

In certain embodiments, the SDAOC 230 may, as part of launching spectrally efficient channel(s), automatically select the (e.g., optimal) number of channels to use and their locations in a flexible grid based on distance considerations. This advantageously takes into account non-linear properties of fibers and varying gain profiles (which can be associated with different reach), thereby ensuring that cach channel is used (e.g., optimized) for its unique characteristics. The SDAOC 230 may thus choose a (e.g., best) location in the flexible grid for channels between two ends of an optical network-based fronthaul/midhaul.

In various embodiments, the AI or ML algorithm(s) may be configured to reduce any error in its predictions or derivations. In this way, any error that may be present may be provided as feedback to the algorithm(s), such that the error may tend to converge toward zero as the algorithm(s) are utilized more and more.

In certain example implementations, the SDAOC 230 may be configured to perform adaptive monitoring of collected or computed data, such as that described above with respect to step 250f of FIG. 2F. The SDAOC 230 may, based on received collected or computed data for NE(s) under test for a given set of parameters, perform an analysis relating to the collected or computed data. For instance, the SDAOC 230 may compare the collected or computed data and historical data to determine whether a difference between the collected or computed data and the historical data (e.g., differences in spectral efficiency, differences in APE, differences in group delay, etc.) is less than a predetermined threshold. Where the SDAOC 230 determines that the difference between the collected or computed data and the historical data is not less than the predetermined threshold, the SDAOC 230 may obtain additional data. This additional data may relate to the status of the NE(s) under test, such as temperature, error logs, troubleshooting logs, and/or the like associated with those NE(s). The SDAOC 230 may analyze this additional data to identify potential factors that may have led to the above-threshold differences, which can inform the SDAOC 230 on particular adjustments that can be made for the NE(s) (e.g., updating firmware in the NE(s), installing or increasing an amount of cooling provided to the NE(s) to prevent overheating, etc.). The SDAOC 230 may then provide commands regarding such adjustments to the NE(s) and/or their management system(s) for implementation. In this way, the SDAOC 230 may limit its collection of additional data relating to NE(s) to when the initially collected or computed data reflects a poor or abnormal condition. This reduces excess requests for data, which avoids excess traffic volume over the network that could otherwise negatively impact network performance. The additional data can be used to analyze the cause of the poor or abnormal condition, thereby providing an improvement over existing NE management systems, resulting in a practical application that improves network/device performance monitoring.

It is to be understood and appreciated that, although one or more of FIGS. 2A to 2F might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various controllers, units, networks, devices, terminals, components, modules, engines, layers, etc. may have been illustrated in one or more of FIGS. 2A to 2E as separate controllers, units, networks, devices, terminals, components, modules, engines, layers, etc., it will be appreciated that multiple controllers, units, networks, devices, terminals, components, modules, engines, layers, etc. can be implemented as a single controller, unit, network, device, terminal, component, module, engine, layer, etc., or a single controller, unit, network, device, terminal, component, module, engine, layer, etc. can be implemented as multiple controllers, units, networks, devices, terminals, components, modules, engines, layers, etc. Additionally, functions described as being performed by one controller, unit, network, device, terminal, component, module, engine, layer, etc. may be performed by multiple controllers, units, networks, devices, terminals, components, modules, engines, layers, etc., or functions described as being performed by multiple controllers, units, networks, devices, terminals, components, modules, engines, layers, etc. may be performed by a single controller, unit, network, device, terminal, component, module, engine, layer, etc.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

FIG. 2G depicts an illustrative embodiment of a method 270 in accordance with various aspects described herein. In some embodiments, one or more process blocks of FIG. 2G can be performed by a controller, such as the SDAOC 230.

At 270a, the method can include determining a topology of a network, wherein the network includes a plurality of network elements (NEs) and at least one optical network-based fronthaul, at least one optical network-based midhaul, or combination thereof. For example, the SDAOC 230 can, similar to that described above with respect to at least the network 200a of FIG. 2A and/or the network 200b of FIG. 2B, perform one or more operations that include determining a topology of a network, wherein the network includes a plurality of network elements (NEs) and at least one optical network-based fronthaul, at least one optical network-based midhaul, or combination thereof.

At 270b, the method can include, for one or more routes associated with one or more of the plurality of NEs identified based on the topology, applying one or more sets of parameters for that route. For example, the SDAOC 230 can, similar to that described above with respect to at least the network 200a of FIG. 2A and/or the network 200b of FIG. 2B, perform one or more operations that include, for one or more routes associated with one or more of the plurality of NEs identified based on the topology, applying one or more sets of parameters for that route.

At 270c, the method can include obtaining data relating to the network based on the applying the one or more sets of parameters. For example, the SDAOC 230 can, similar to that described above with respect to at least the network 200a of FIG. 2A and/or the network 200b of FIG. 2B, perform one or more operations that include obtaining data relating to the network based on the applying the one or more sets of parameters.

At 270d, the method can include training one or more AI models using the data, resulting in one or more trained AI models. For example, the SDAOC 230 can, similar to that described above with respect to at least the network 200a of FIG. 2A and/or the network 200b of FIG. 2B, perform one or more operations that include training one or more AI models using the data, resulting in one or more trained AI models.

At 270e, the method can include utilizing the one or more trained AI models to generate one or more predictions regarding spectral efficiency relating to the at least one optical network based fronthaul, the at least one optical network-based midhaul, or the combination thereof. For example, the SDAOC 230 can, similar to that described above with respect to at least the network 200a of FIG. 2A and/or the network 200b of FIG. 2B, perform one or more operations that include utilizing the one or more trained AI models to generate one or more predictions regarding spectral efficiency relating to the at least one optical network based fronthaul, the at least one optical network-based midhaul, or the combination thereof.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

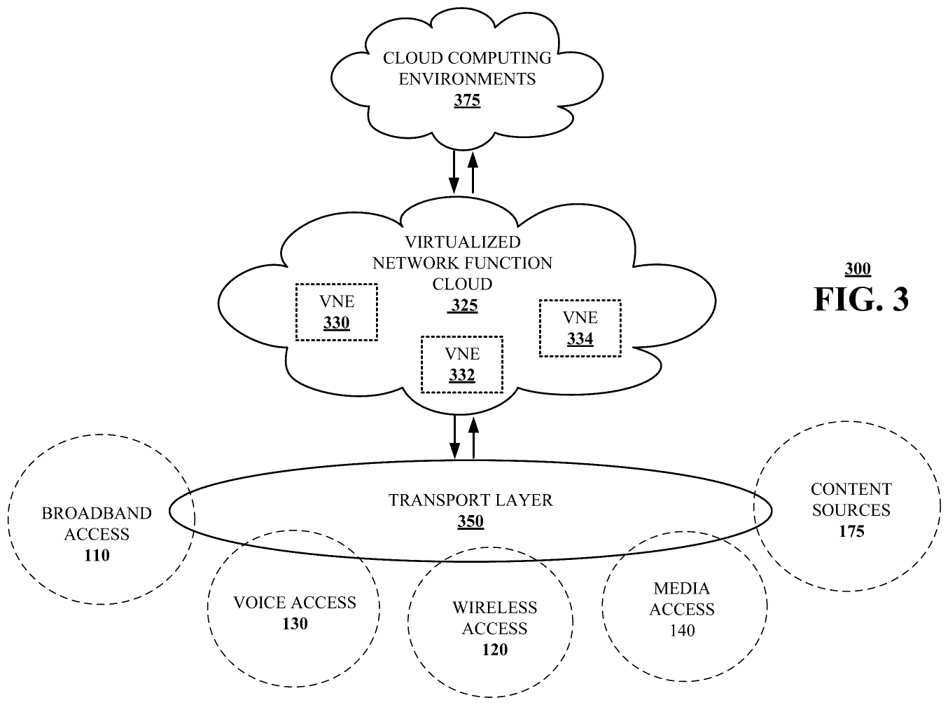

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of the systems/methods presented in one or more of FIGS. 2A to 2G. For example, virtualized communications network 300 can facilitate, in whole or in part, efficient spectrum allocations e.g., for a 5G (or higher generation technology) optical network-based fronthaul and/or midhaul.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network clement function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers-each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

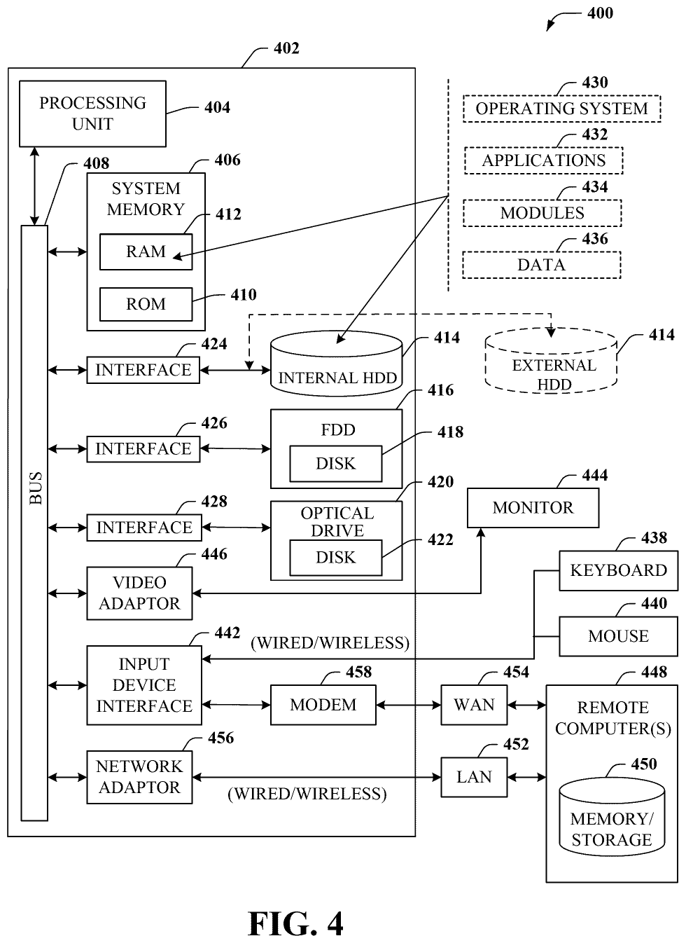

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, efficient spectrum allocations—e.g., for a 5G (or higher generation technology) optical network-based fronthaul and/or midhaul.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, cach of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

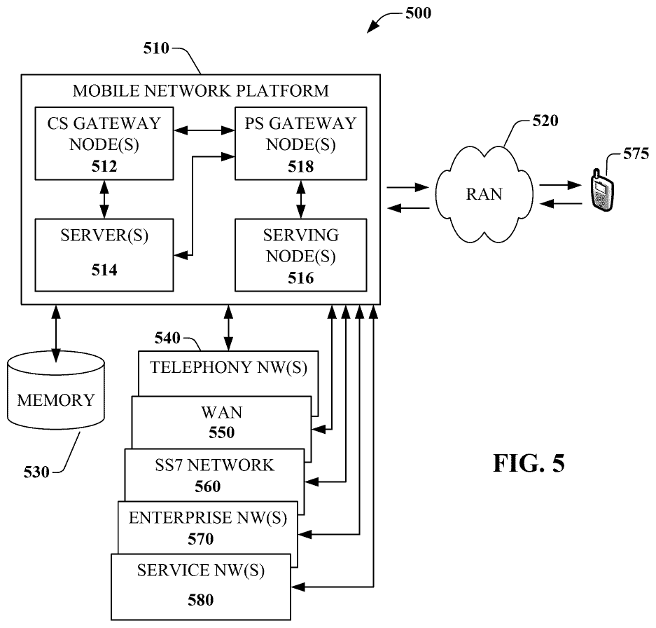

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, efficient spectrum allocations—e.g., for a 5G (or higher generation technology) optical network-based fronthaul and/or midhaul. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

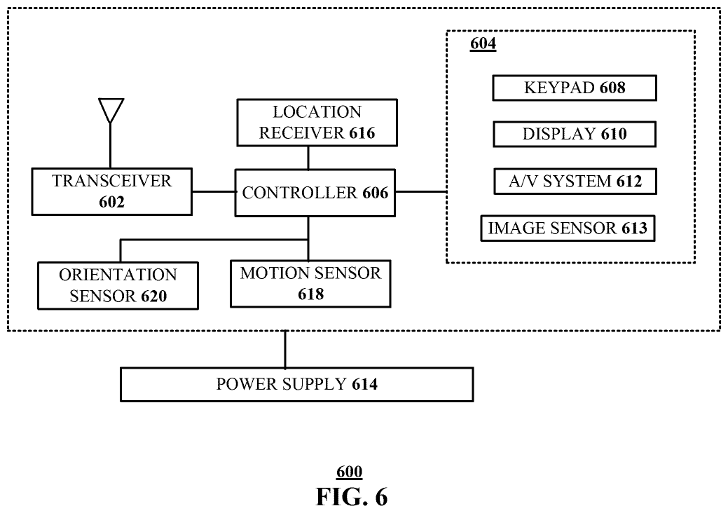

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, efficient spectrum allocations e.g., for a 5G (or higher generation technology) optical network-based fronthaul and/or midhaul.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, X=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
determining a topology of a network, wherein the network includes a plurality of network elements (NEs) and at least one optical network-based fronthaul, at least one optical network-based midhaul, or a combination thereof;
for one or more routes associated with one or more of the plurality of NEs identified based on the topology, applying one or more sets of parameters for that route;
obtaining data relating to the network based on the applying the one or more sets of parameters;
training one or more artificial intelligence (AI) models using the data, resulting in one or more trained AI models; and
utilizing the one or more trained AI models to generate one or more predictions regarding spectral efficiency relating to the at least one optical network-based fronthaul, the at least one optical network-based midhaul, or the combination thereof.

2. The device of claim 1, wherein the applying comprises applying the one or more sets of parameters to one or more of the plurality of NEs or to one or more other components of the network.

3. The device of claim 1, wherein the plurality of NEs includes one or more central units (CUs), one or more distributed units (DUs), one or more remote units (RUs), or a combination thereof.

4. The device of claim 1, wherein the at least one optical network-based fronthaul or the at least one optical network-based midhaul is implemented in a passive optical network (PON).

5. The device of claim 1, wherein the at least one optical network-based fronthaul or the at least one optical network-based midhaul is implemented in a wavelength division multiplexing (WDM) network.

6. The device of claim 1, wherein the operations further comprise utilizing the one or more trained AI models to generate one or more recommendations regarding one or more frequencies of one or more channels to utilize in the at least one optical network-based fronthaul or the at least one optical network-based midhaul.

7. The device of claim 1, wherein the one or more sets of parameters include optical laser type, laser frequency, laser intensity, number of channels, channel bandwidth, data modulation format, forward error correction (FEC) type, or a combination thereof.

8. The device of claim 1, wherein the network comprises a 5G network or a higher generation network and conforms to Open-Radio Access Network (O-RAN) standards.

9. The device of claim 1, wherein the one or more AI models include one or more deep learning (DL) models.

10. The device of claim 1, wherein the obtaining the data involves computations relating to spectral efficiency, asymptotic power efficiency, average symbol rate, average energy per bit, signal attenuation per unit length, Stimulated Brillouin Scattering (SBS), Stimulated Raman Scattering (SRS), Rayleigh Scattering, material dispersion, dispersion in single mode fiber, group delay, or a combination thereof.

11. A non-transitory machine-readable medium, comprising executable instructions that, when executed by a processing system including a processor, facilitate performance of operations, the operations comprising:
determining a topology of a network, wherein the network includes a plurality of nodes and at least one optical network-based fronthaul;
for one or more network paths associated with one or more of the plurality of nodes identified based on the topology, applying one or more sets of parameters to one or more components associated with that network path;
collecting data relating to the network based on the applying the one or more sets of parameters;
training one or more deep learning (DL) models using the data, resulting in one or more trained DL models; and
utilizing the one or more trained DL models to generate one or more predictions regarding spectral efficiency relating to the at least one optical network-based fronthaul.

12. The non-transitory machine-readable medium of claim 11, wherein the plurality of nodes includes one or more central units (CUs), one or more distributed units (DUs), one or more remote units (RUs), or a combination thereof.

13. The non-transitory machine-readable medium of claim 11, wherein the at least one optical network-based fronthaul is implemented in a passive optical network (PON).

14. The non-transitory machine-readable medium of claim 11, wherein the at least one optical network-based fronthaul is implemented in a wavelength division multiplexing (WDM) network.

15. The non-transitory machine-readable medium of claim 11, wherein the network comprises a 5G network or a higher generation network.

16. A method, comprising:
obtaining, by a processing system including a processor, information regarding a topology of a network, wherein the network includes a plurality of nodes and at least one optical network-based fronthaul, at least one optical network-based midhaul, or a combination thereof;
for one or more routes associated with one or more of the plurality of nodes identified based on the topology, applying, by the processing system, one or more sets of parameters to one or more components associated with that route;
performing, by the processing system, testing of the network to obtain data relating to the network based on the applying the one or more sets of parameters;
training, by the processing system, one or more machine learning (ML) models using at least a portion of the data, resulting in one or more trained ML models;
leveraging, by the processing system, the one or more trained ML models to generate one or more predictions regarding spectral efficiency relating to the at least one optical network-based fronthaul, the at least one optical network-based midhaul, or the combination thereof; and
causing, by the processing system, one or more adjustments to be made to at least a portion of the network based on the one or more predictions.

17. The method of claim 16, wherein the plurality of nodes includes one or more central units (CUs), one or more distributed units (DUs), one or more remote units (RUs), or a combination thereof.

18. The method of claim 16, wherein the at least one optical network-based fronthaul or the at least one optical network-based midhaul is implemented in a passive optical network (PON).

19. The method of claim 16, wherein the at least one optical network-based fronthaul or the at least one optical network-based midhaul is implemented in a wavelength division multiplexing (WDM) network.

20. The method of claim 16, wherein the network comprises a 5G network or a higher generation network.
